(19) United States
(12) Patent Application Publication
(10) Pub. No.: US 2009/0050602 A1
(43) Pub. Date: Feb. 26, 2009

(54) METHOD FOR FORMING HOLES IN MAKING PRINTED CIRCUIT BOARD

(75) Inventors: CHENG-HSIEN LIN, Tayuan (TW); WEN-CHIN LEE, Tayuan (TW); KAI-LI JIANG, Beijing (CN)

Correspondence Address: PCE INDUSTRY, INC.;ATT. CHENG-JU CHIANG, 458 E. LAMBERT ROAD, FULLERTON, CA, 92835, US

(73) Assignees: TSINGHUA UNIVERSITY, Beijing (CN); HON HAI PRECISION INDUSTRY CO., LTD., Tu-Cheng (TW)

(21) Appl. No.: 12/135,843

(22) Filed: Jun. 9, 2008

(30) Foreign Application Priority Data
Aug. 24, 2007 (CN) 200710076554.X

(51) Int. Cl. H01B 13/00

(52) U.S. Cl. 216/17

(57) ABSTRACT

A method for forming holes in making a printed circuit board includes the step of: providing a copper clad laminate including an insulation layer and a copper layer laminated on the insulation layer; forming a carbon nano-material on the copper layer of the copper clad laminate; and applying a laser beam onto a portion of the carbon nano-material to define a hole in the copper clad laminate beneath the portion of the carbon nano-material.

### BACKGROUND OF THE INVENTION

1. Field of the Invention

The present invention relates to methods for manufacturing printed circuit boards (FPCBs) and, particularly, to a method for forming holes in making a printed circuit board.

2. Description of Related Art

Nowadays, flexible printed circuit boards (FPCBS) are widely used in portable electronic devices such as mobile phones, digital cameras and personal digital assistants (PDAS). In some electronic devices, certain parts are movable relative to a main body. In these electronic devices, FPCBS can maintain an electrical connection between the main body and the movable parts due to their flexibility.

Conventionally, via-holes in the FPCB are formed by the following steps. Firstly, the base film is rinsed in a cleaning solution to remove surface oils of the copper film. Secondly, a photo-resist layer is formed on the surface of the copper film. Thirdly, the photo-resist layer is exposed to a light beam using a mask having a predetermined pattern. Thus, some portions of the photo-resist layer are covered by the mask, while the other portions of photo-resist layer are exposed and irradiated by the light beam. When the photo-resist layer is made of a positive photo-resist, the uncovered photo-resist layer (i.e. the exposed portions of the photo-resist layer) is changed to be soluble in a developing agent. Fourthly, the base film having the photo-resist layer is developed in the developing agent. During the developing process, the exposed portions of the photo-resist layer are dissolved in the developing agent and form a patterned photo-resist layer. Thus, some portions of the copper film are covered by the patterned photo-resist layer, and other portions of the copper film are exposed to the outside. Fifthly, the base film having the patterned photo-resist layer is arranged in an etching solution, and the portions of the copper film not covered by the photo-resist layer are dissolved by the etching solution. As a result, the dissolved portions of the copper film form a number of via-holes. Finally, the photo-resist layer covering the copper film is eliminated.

In the above method for forming via-holes, the base film is exposed in liquid solutions (e.g., the cleaning solution, the developing agent, the etching solution) repeatedly, and the liquid solution may inevitably penetrate into the base film. Thus, an original characteristic of the base film may be altered, thereby affecting the quality of the FPCB manufactured by such base film. In addition, the method involves a number of processes and a manufacturing efficiency of the FPCB is relatively low, thereby affecting the mass-production of the FPCB.

What is need, therefore, is a method for forming holes in making a printed circuit board which can overcome the above problems.

### SUMMARY OF THE INVENTION

An exemplary embodiment of a method for forming holes in making a printed circuit board includes the step of: providing a copper clad laminate including an insulation layer and a copper layer laminated on the insulation layer; forming a carbon nano-material on the copper layer of the copper clad laminate; and applying a laser beam onto a portion of the carbon nano-material to define a hole in the copper clad laminate beneath the portion of the carbon nano-material.

Advantages and novel features will become more apparent from the following detailed description when taken in conjunction with the accompanying drawings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a flowchart of a process for forming holes in making a printed circuit board, in accordance with an exemplary embodiment.

FIGS. 2-7 are schematic view of the specific steps of FIG. 1.

### DETAILED DESCRIPTION OF THE INVENTION

Embodiments will now be described in detail below and with reference to the drawings.

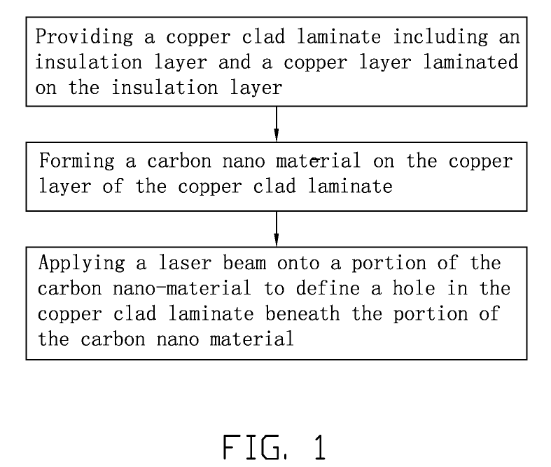

Referring to FIG. 1, a method for forming holes in making a printed circuit board includes the steps of: providing a copper clad laminate including an insulation layer and a copper layer laminated on the insulating layer; forming carbon nano-material on a surface of the copper layer of the copper clad laminate; applying a laser beam onto a portion of the carbon nano-material to form a hole in the copper clad laminate beneath the portion of the carbon nano-material. The copper clad laminate can be a rigid printed circuit board or a flexible printed circuit board. The copper clad laminate can be a single-sided printed circuit board or a double-sided printed circuit board. The copper clad laminate can be a single layer printed circuit board or a multilayer printed circuit board. The carbon nano-material can be a carbon nano-tube array or a carbon nano-material film. The carbon nano-material film can be a carbon nano-tube film, a carbon nano-particle film, or a carbon fiber film.

An exemplary embodiment of a method for forming holes during making a flexible printed circuit board includes the following steps.

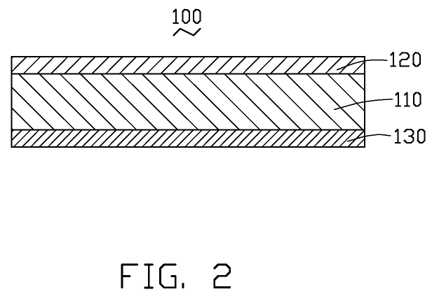

In a first step, as shown in FIG. 2, a double-sided copper clad substrate 100 is provided. The copper clad substrate 100 includes an insulation base 110, a first copper foil 120 formed on one surface of the insulation base 110, and a second copper foil 130 formed on another surface on opposite side of the insulation base 110.

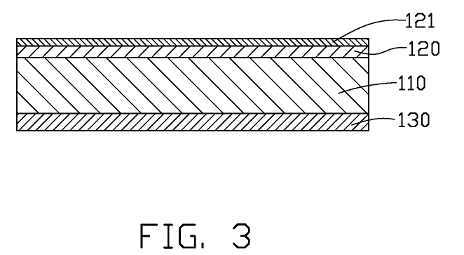

In a second step, as shown in FIG. 3, a catalyst layer 121 is formed on a surface of the first copper foil 120. A material of the catalyst layer 121 may be iron, cobalt, nickel, or alloy thereof. In the present embodiment, the catalyst layer 121 is comprised of iron. The catalyst layer 121 may be formed on the surface of the first copper foil 120 using deposition method such as electron beam deposition, heat deposition, sputtering, and so on. After the catalyst layer 121 is formed, the copper clad substrate 100 with the catalyst layer 121 is exposed to the air, and the catalyst layer 121 is heat processed for about ten hours under high temperature, e.g., from about 300 degrees Celsius to about 400 degrees Celsius, to oxidize the catalyst layer 121. Then the oxidized catalyst layer 121 is annealed to be catalyst grain for facilitating the growth of the sequential carbon nano-tube array thereon.

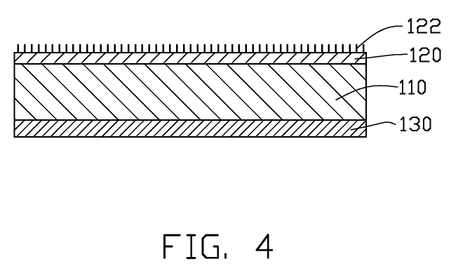

In a third step, as shown FIG. 4, an carbon nano-tube array 122 is grown on a surface of the catalyst layer 121 using the typical chemical vapor deposition (CVD) method. In detail, the copper clad substrate 100 with the catalyst layer 121 is placed in a chamber filled with a protective gas such as nitrogen, argon, or other inert gas, and is heated to a suitable temperature, e.g., 500 degrees Celsius to 700 degrees Celsius. Then a carbon resource gas or a mixture of the carbon resource gas and a protective gas is introduced into the chamber to do reaction. Reacting for a certain time, the carbon nano-tube array 122 is grown on the copper clad substrate 100. In the present embodiment, the protective gas is argon, the carbon resource gas is acetylene, the temperature in the chamber is about 600 degrees Celsuis, and the reaction time is about five to thirty minutes.

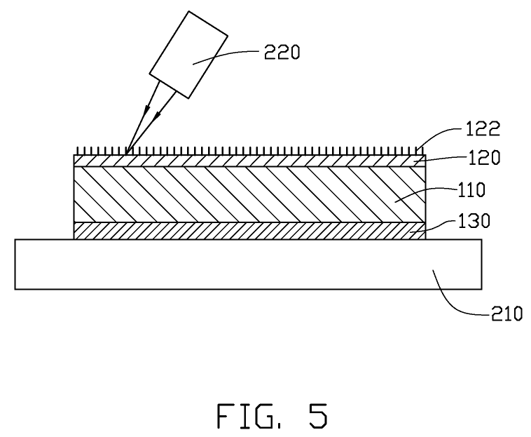

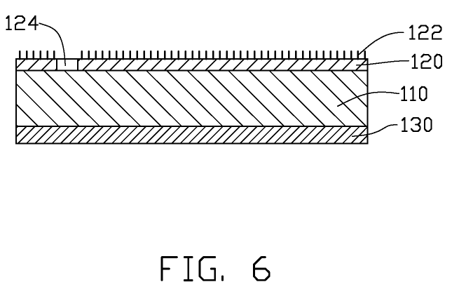

Finally, applying a laser beam onto a portion of the carbon nano-tube array 122 to form a hole in the copper clad substrate 100 beneath the portion of the carbon nano-tube array 122. As shown in FIG. 5, a typical laser device includes a platform 210 and a laser source 220. Parameters (e.g., frequency, spot size, etc.) of the laser source 220 can be adjusted according to the requirements of the drilling process. The laser beam emitted from the laser source 220 is absorbed by the carbon nano-tube array 122. In the process forming the hole, the copper clad substrate 100 with the carbon nano-tube array 122 is fixed on a surface of the platform 210, and the laser source 220 is adjusted for allowing the laser beam aiming at the a predetermined portion of a surface of the carbon nano-tube array 122. The laser source 220 is activated and emit laser beam bombarding the predetermined portion of the carbon nano-tube array 122. The carbon nano-tube array 122 can strongly absorb a mass of heat energy of the laser, therefore, a temperature of the carbon nano-tube array 122 rises rapidly. Thus, the heat energy absorbed by the carbon nano-tube array 122 is transmitted to a portion of the first copper foil 120 contacting with the predetermined portion of the carbon nano-tube array 122, thereby such portion of the first copper foil 120 is burnt and gasified due to absorption of the heat energy transmitted by the carbon nano-tube array 122. As a result, the gasified portion of the first copper foil 120 forms a first hole 124, as shown in FIG. 6. In such fashion, a number of first holes 124 can be formed. The laser source 220 can be an ultraviolet source such as Nd:YAG laser or an infrared source such as a CO2 laser. In the present process for forming the first hole 124, the laser source 220 is the Nd:YAG laser.

After the hole 124 is formed, the carbon nano-tube array 122 can be removed using a suitable chemical solution. For example, the chemical solution can be a liquid mixture of sodium persulfate (SPS) and sulfuric acid (H2SO4), or a liquid mixture of sodium persulfate (SPS) and hydrogen peroxide (H2O2).

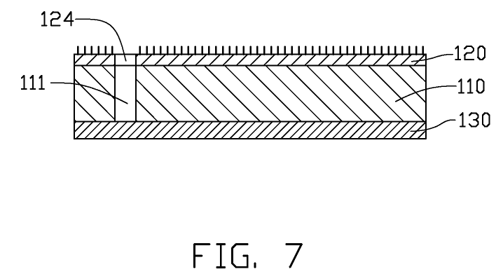

In the above-mentioned embodiment, if a second hole 111 in the insulation base 110 registering/corresponding to the first hole 124 formed in the first copper foil 120 needs to be formed additionally, a portion of the insulation base 110 corresponding to the first hole 124 is formed by CO2 laser beam. The insulation base 110 can strongly absorb the heat energy of the CO2 laser, therefore, a temperature of the portion of the insulation base 110 rises rapidly. Thus, the portion of the insulation base 110 is burnt and gasified due to absorption of the heat energy of the CO2 laser. As a result, the gasified portion of the insulation base 110 forms the desired second hole 111 communicating with the first hole 124, as shown in FIG. 7. In such fashion, a number of second holes 111 communicating with a number first holes 124 are formed. Furthermore, inner walls of the first holes 124 and the second holes 111 need to be metallized to electrically connect to the first copper foil 120 and the second copper foil 130. For example, a metal layer such as a copper layer is plated on the inner walls of the first holes 124 and the second holes 111 using an electro-plating method. Thus, the metallized first and second holes 124, 111 electrically connect with a sequential circuit formed on the first copper foil 120 and a sequential circuit formed on the second copper foil 130.

Alternatively, an intermediate layer can be formed between the first copper foil 120 and the carbon nano-material (e.g., the carbon nano-tube array 122) to facilitate the carbon nano-material being formed thereon and to intensify a rigidity of the first copper foil 120. The intermediate layer can be comprised of one of nickel, aluminum and aluminum oxide. In addition, after the metallized first and second via-holes 124, 111 have been formed, the carbon nano-material (e.g., the carbon nano-tube array 122) can be removed by the above-mentioned chemical solution, and the intermediate layer can be removed by an alkaline.

In the present embodiment of the method for forming holes, the carbon nano-tube array 122 formed on the first copper foil 120 has a high thermal conductivity along axes of the carbon nano-tubes. When the laser beam bombard the predetermined portion of the carbon nano-tube array 122, the carbon nano-tube array 122 can strongly absorb the heat of the laser and transfer the heat rapidly along axes of the carbon nano-tubes to a portion of the first copper foil 120 contacting with the predetermined portion of the carbon nano-tube array 122. As a result, the portion of the first copper foil 120 contacting with the predetermined portion of the carbon nano-tube array 122 is gasified and forms a first hole 124. Because the carbon nano-material (e.g., the carbon nano-tube array 122) strong absorbs the energy of laser beam, thus the quantity of the laser beam used in the drilling process of forming holes can be saved. Therefore, the cost of the laser beam is lowered correspondingly.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for forming holes in making a printed circuit board, the method comprising:
providing a copper clad laminate comprising an insulation layer and a copper layer laminated on the insulation layer;
forming a carbon nano-material on the copper layer of the copper clad laminate; and
applying a laser beam onto a portion of the carbon nano-material to define a hole in the copper clad laminate beneath the portion of the carbon nano-material.

2. The method as claimed in claim 1, wherein the carbon nano-material is selectively formed on the surface of the copper layer where the hole is to be formed.

3. The method as claimed in claim 1, wherein the carbon nano-material is one of a carbon nano-tube film, a carbon nano-particle film and a carbon fiber film.

4. The method as claimed in claim 1, wherein the carbon nano-tube film comprises a carbon nano-tube array.

5. The method as claimed in claim 1, further comprising forming a catalyst layer on the surface of the copper layer of the copper clad laminate before forming the carbon nano-material.

6. The method as claimed in claim 5, wherein the catalyst layer is comprised of nickel, aluminum, or aluminum oxide.

7. The method as claimed in claim 1, wherein the carbon nano-material is removed from the surface of the copper layer of the copper clad laminate after the hole is formed in the copper layer.

8. A method for forming holes during making a printed circuit board, the method comprising:
providing a copper clad laminate comprising an insulation film, a first copper film formed on the insulation film, and a second copper film formed on an opposite side of the insulation film to the first copper film;
forming a carbon nano-material on a surface of the first copper film;
applying a first laser beam on the carbon nano-material to form a first hole in the first copper film; and
applying a second laser beam to the insulation film via the first hole to form a second hole in the insulation film, thereby obtaining the second hole respectively communicating with the corresponding first hole.

9. The method as claimed in claim 8, wherein the first laser beam is generated using a Nd:YAG laser source.

10. The method as claimed in claim 8, wherein the second laser beam is generated using a CO2 laser source.
